(19) United States
(12) Patent Application Publication
(10) Pub. No.: US 2007/0037561 A1
(43) Pub. Date: Feb. 15, 2007

(54) Method for intelligently dialing contact numbers for a person using user-defined smart rules

(76) Inventors: Blake A. Bowen, Arlington Heights, IL (US); Jay D. O'Connor, Chicago, IL (US)

Correspondence Address: MOTOROLA, INC., 1303 EAST ALGONQUIN ROAD, IL01/3RD, SCHAUMBURG, IL, 60196, US

(21) Appl. No.: 11/200,595

(22) Filed: Aug. 10, 2005

(51) Int. Cl. H04M 3/00

(52) U.S. Cl. 455/418

(57) ABSTRACT

Methods for establishing communication with a person using a communication device such as a cell phone are disclosed. The communication device has two or more contact numbers for establishing communication with a particular the person (e.g., work, home or cell), such as might be programmed into a the cell phone's phonebook. The user defines calling rules for the person, and the rules are associated with the various contact numbers of the person. When the user selects to communicate with the person, the communication device initiates a call based on the user-defined rules, such that the user need not specify any particular contact number for the person. The user-defined rules can include a preferred order of the numbers for calling the person, a preferred period of time by which the various numbers of the person are to be used to call the person, or a combination thereof.

### FIELD OF THE PRESENT DISCLOSURE

This invention relates to communication devices such as cellular telephones and to methods for intelligently dialing contact numbers for a person using user-defined rules.

### BACKGROUND OF THE PRESENT DISCLOSURE

Referring to FIG. 1, conventional components of a communication device 100 of the prior art are schematically illustrated in block diagram. For convenience, the communication device 100 is exemplified by a cellular telephone (or cell phone for short), although it could comprise any similar device, such as a personal digital (data) assistant (PDA), a communication device integrated into a vehicle for communication over a network such as a wireless network or the Internet, a laptop computer, etc. These conventional components 110-150 are well known in the art and are thus not described in detail. Briefly, the communication device 100 includes a memory 110, processing circuitry or processor 120, a display device 130, an input device 140, and communication circuitry 150.

The processing circuitry 120 for the cell phone 100 includes one or more processors that handle all the signal processing from the input device 140 (e.g., keypad, touchscreen, etc.) and to the display device 130 (e.g., screen). The processor 120 also handles command and control signaling with a base station (not shown) via the communication circuitry 150. The memory 110 for the cell phone 100 is configured to store, among other information, contact information (e.g., names and phone numbers) input into the device 100 via input device 140. The memory 110 is typically a Flash EPROM memory chip or other type of electrically-erasable non-volatile memory chip, and stores the operating system and other user-customizable features such as a phone directory containing the contact information of various persons.

Most users of cell phones 100 store in their phones a number of different contact numbers for a particular person the user might wish to call. A given person can have a home phone number, a work phone number, a cellular phone number, a fax number, an e-mail address, etc. Therefore, for the user to contact such a person, the user must select from multiple entries of contact numbers stored in the cell phone 100 for that person. This is because, of course, calling the person at one of the numbers may be more logical depending on the circumstances, and because selection of one the numbers may not be successful in reaching the person at a particular place or time (e.g., at home during working hours), which would require the caller to then try a different stored number (e.g., the person's cell phone), etc. However, having to call one of several contact numbers for a person is cumbersome and time consuming to the user.

Accordingly, the art would benefit from a simpler technique for allowing a user to call one of a plurality of contact numbers stored in a communication device such as a cell phone for a particular person.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 depicts a block diagram of an exemplary communication device (e.g., a cell phone) according to the prior art.

FIG. 2 illustrates an embodiment of a communication device having an exemplary phonebook interface including a “smart” entry according to certain teachings of the present disclosure.

FIG. 3 illustrates a flow chart of an embodiment for programming and dialing a “smart” phonebook entry according to a set of user-defined rules.

FIG. 4 illustrates a flow chart of user-defined contact rules for a “smart” phonebook entry.

FIG. 5 illustrates a flow chart of user-defined automation rules for a “smart” phonebook entry.

While the disclosed is susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. § 112.

### DETAILED DESCRIPTION

Methods for establishing communication with a person using a communication device, such as a cell phone, are disclosed. The cell phone is programmed with a plurality of contact numbers for establishing communication with the person. User-defined rules are associated with the contact numbers of the person and also stored in memory. A selection to initiate communication with the person interrogates these user-defined rules, which in turn dictates which of the plurality of contact numbers should be called for the person.

In one embodiment, the user-defined rules include a preferred, user-defined order for initiating communication with the person. For example, when the person is selected for contact by the communications device, communication is initiated by dialing a preferred first number of the user-defined order. If communication is not established with the first number, then communication is initiated with a second number of the user-defined order, etc. Such contact with a second preferred contact number can be automatic (i.e. when the first preferred number fails), or can be in response to the user once again dialing the person.

In another embodiment, the user-defined rules include a preferred, user-defined time period for initiating communication with the person using contact numbers. For example, a current time value is determined after the receiving the selection to initiate communication. Then, communication with the person is initiated by using a contact number associated with the user-defined period encompassing the current time value. In other embodiments, the user-defined rules include a combination of a user-defined period and a user-defined order of contact numbers for a person.

In yet another embodiment, the cell phone has a “smart” entry in a phonebook interface, such that when the “smart” entry is selected, the phone initiates the communication process based on the smart rules defined by the user, as discussed above. Thus, once the rules are defined for a particular person to be contacted, the user need only select the person via the smart entry to communicate, without the need to specify a particular one of the plurality of contact numbers for the person.

The ways of determining call failure to a first contact number and initiating a call to a second contact number can also be controlled by user defined rules. For example, a user can define the number of rings or elapsed time period before deeming a first call a failure and commencing dialing to a next (preferred) number as specified by user rules.

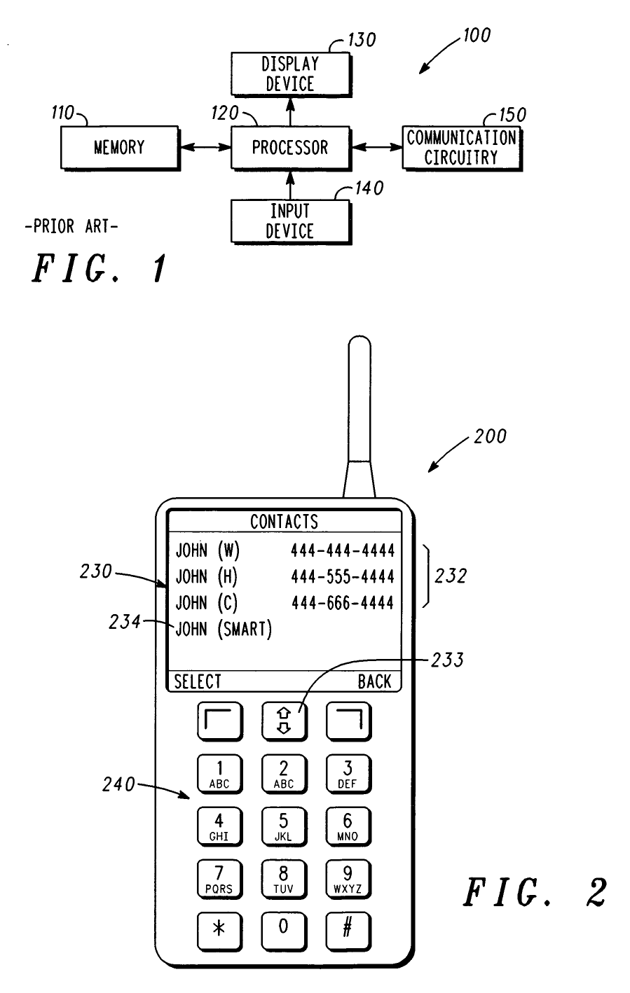

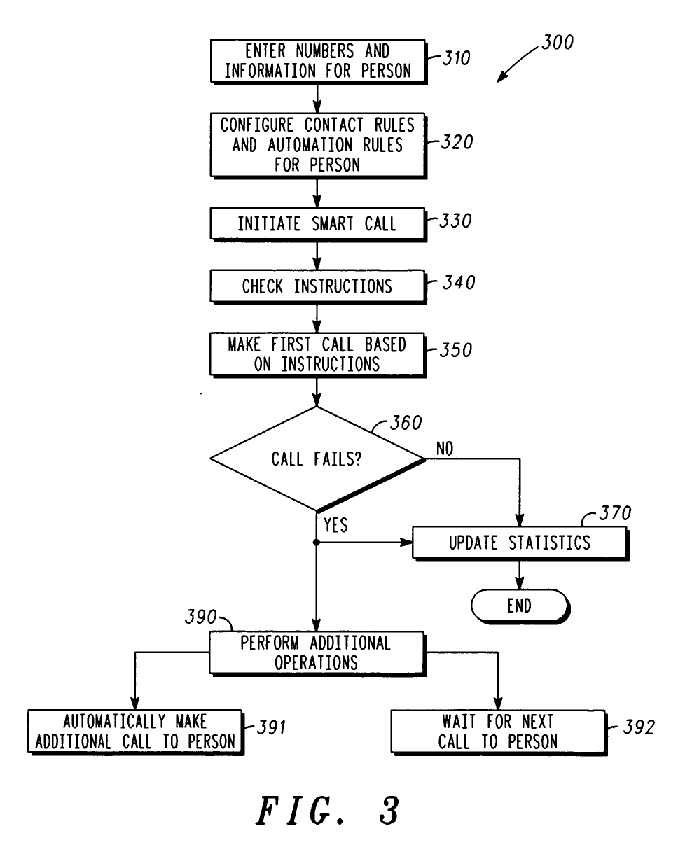

Referring now to the figures, an embodiment of a communication device 200 is illustrated in FIG. 2. While the communication device 200 can comprise devices such as PDAs, etc., as noted earlier, for convenience the embodiment of a cell phone 200 is described. Various components of the cell phone 200, such as those discussed above with reference to FIG. 1, are known in the art and thus are not described in detail herein. Briefly, the cell phone 200 includes a memory (not shown), processing circuitry or processor(s) (not shown), communication circuitry (not shown), a display device or screen 230, an input device such as a keypad 240 or touchscreen. The memory, as most relevant to embodiments of the invention, is configured to store contact information for various persons, and to store “smart dialing” rules as will be discussed in further detail herein.

As shown in FIG. 2, the display device 230 shows an exemplary phonebook interface with traditional entries 232 (e.g., work (W), home (H), and cell (C)) for a person (“John”). Also shown, and as particularly relevant to an embodiment of the invention, is a “smart” entry 234 which allows John to be contacted according to certain “smart dial” teachings of the present disclosure, which will be described further below. Entry of the various names and numbers stored in the memory of the device 200 is made through any known means in the art, including use of the keypad, etc. Once entries are programmed for a particular person, the user can then open the phonebook interface to access the stored contact information.

By selecting one of the listed entries in the phonebook interface such as by use of up/down arrow key 233, a user can initiate a call to a number of the selected entry. Thus, the user in one embodiment can select one of the traditional entries 232 (e.g., John (W) 444-444-4444) or the “smart” entry 234 (e.g., John (Smart)) from the phonebook interface. If a traditional entry 232 is selected, the phone 200 dials the number of the selected entry 232 according to conventional operation of the phone 200. If the “smart” entry 234 is selected however, the phone 200 initiates a call to the selected person according to the rules defined by the user and stored in the phone 200, as described below.

Once user smart dialing rules have been defined, the interface may only display a smart entry 234 for a person without also displaying traditional entries 232. Thus, the user would need only to select the smart entry 234 to call the person based on the user-defined rules. In another embodiment, the interface may only display one or more traditional entries 232, but may operate the phone 200 according to the user-defined rules when any of the entries 232 are selected. Finally, the interface may display nothing regarding the person to be smart dialed at all; for example, after programming the smart entry, the user may simply need to press and hold the ‘5’ key (corresponding to ‘J’ for “John.”) to smartly dial John in the various ways disclosed herein. It will be appreciated that one skilled in the art could implement an acceptable interface for a cell phone in any of these manners so as to allow smart dialing as disclosed herein.

Regardless, selecting the “smart” entry 234 enables the user to initiate a call to the person based on user-defined smart dialing rules pursuant to which one of more of the contact numbers for the person may automatically be chosen for dialing depending on the circumstances as discussed below. Before discussing these various smart dialing scenarios, FIG. 3 discloses a flow chart of the process for programming a cell phone 200 with smart dialing rules, and for handling of a call once a smart dial has been initiated from the phone 200.

At step 310, the user programs the cell phone 200 by entering information for a person to be contacted, such as name, the various contact numbers for the person, etc. In general, the contact numbers can be a home phone number, a work phone number, a cellular phone number, a fax number, and other less traditional information considerable herein as a dialable “number” such as an e-mail address.

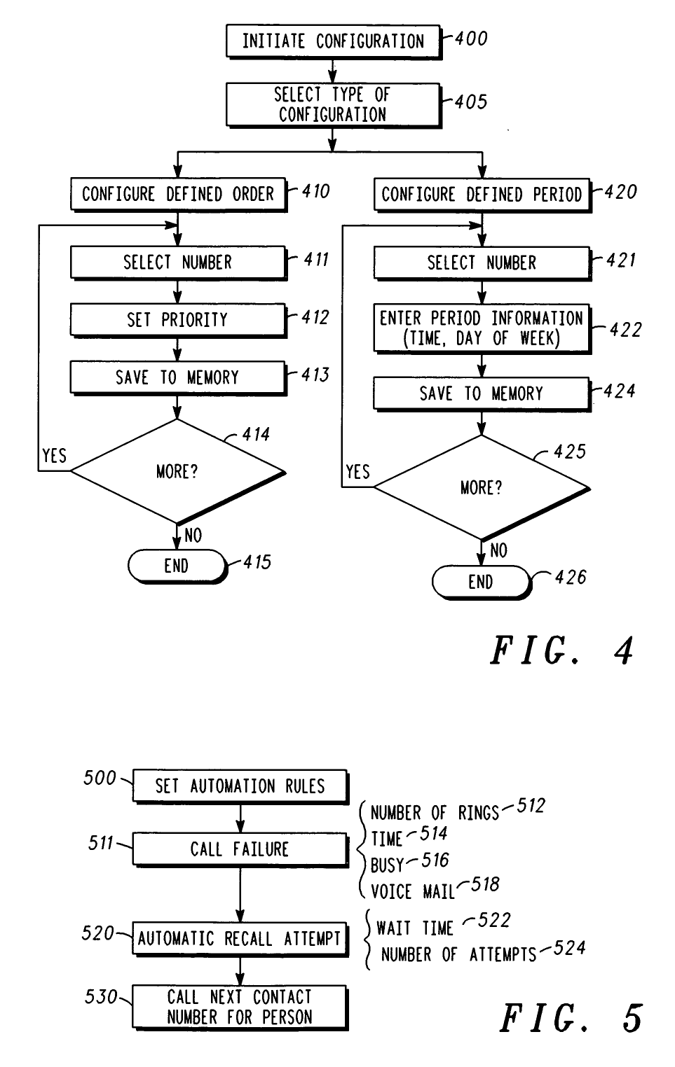

Thereafter, the user configures “contact rules” and “automation rules” for the person at step 320. For example, the user can specify an order in which the person's contact numbers are to be called (work, then home, then cell), or a preferential contact number to be first dialed depending on a time period the call is made (day time v. night time; week days v. week ends, etc.), or combinations of both of these approaches. Such contact rules as these will be explained in further detail below with respect to FIG. 4. Additionally, because some of the smart dialing schemes disclosed herein have a sequential nature, in which a first contact number for a person is tried, followed by a second contact number, step 320 can also include user-defined rules as to when a particular call to a contact number will be deemed a failure, such that the next number is tried, etc. Such “automation rules” will be explained in further detail below with respect to FIG. 5.

Once the contact information has been entered (step 310) and the contact and automation rules defined (step 320), the user can initiate a call to the person by selecting a “smart” entry from the interface of the device, again in any of the manners set forth above (step 330). Upon selection of the smart entry, the phone 200 checks the user-defined contact and automation rules for the person as stored in memory for how to conduct the call (or calls) to the selected person at step 340, i.e., which of the various contact numbers to call for the person, in what order, how to determine if a call is a failure and dial a next number, etc.

Based initially on the contact rules, the device then makes a first call to a preferred first contact number at step 350. Thereafter, a determination is made at step 360 whether the call was successful or was a failure as defined by the automation rules. Regardless of the call's success, statistics for the contact number dialed are preferably updated at step 370 so that such data can be stored in memory and potentially used for other purposes disclosed herein. For example, although the contact rules (see FIG. 4) are at least initially based on user preferences, such statistical information can possibly be used to modify those preferences. For example, should statistics show that calls to a particular contact number are rarely successful, then the position of that contact number might be demoted in a preferred calling order. In another example, if statistics show that a particular contact number (home) is rarely answered at a particular time (working hours) of day, the decision might be made (despite the caller's initial preferences) to change to the person's work number as the priority number for working-hour calls. In other embodiments of the invention however, utilization of statistics are not required, and instead, smart dialing occurs purely on the basis of the user's programmed rules.

If the call was not successful at step 360 per the automation rules (e.g., there is no answer after a certain number of rings, a voice mail message is received, a busy signal received, etc.), the cell phone 200 can, according to another embodiment of the invention, perform one or more additional calling functions at step 390, preferably according to user-defined automation rules. For example, the cell phone 200 can attempt again to reach the person by automatically making one or more additional calls at step 391. In other words, the cell phone 200 can automatically proceed to call the next contact number for the person as set up by the user in a preferred calling order associated with the “smart” entry for the selected person. For example, if a call to a first preferred number (e.g., a work number) for the person is not answered at step 360, the phone 200 can automatically dial the next preferred number (e.g., a cell number) without the user having to select anything further from the cell phone 200.

In another embodiment shown in step 392, the cell phone 200 may wait until the user actually initiates another call to the same person at some later point in time. For example, a call to a first preferred number in a user-defined calling order may have failed (i.e., at step 360). However, instead of automatically calling another (next) contact number for the person, the cell phone 200 may wait to see if the caller wishes to try and smart call the same person again, perhaps within some specified amount of time (e.g., 30 minutes later). If the user does so attempt to smart call the person again, the cell phone 200 will now select the second preferred number pursuant to the user's defined rules, even though the user does not expressly select that second number.

As discussed previously, the disclosed technique enables the user to define rules that instruct a cell phone how to initiate communication with a selected person for whom a plurality of contact numbers is entered. Configuring such rules for a person can be performed after the user has entered contact information into his/her cell phone 200, e.g., after entering the various contact numbers, or such rules can be configured concurrently with the process of entering contact information into the device 200.

FIG. 4 illustrates a flow chart for how a user can specify or program smart dialing preferences in accordance with the contact rules alluded to earlier. It should be noted that one skilled in the art who understands the functionality of the smart dialing features as disclosed herein would know how to provide options on the cell phone 200 to allow a user to program such contact rules into a cell phone 200 using the user interface (keypad, touchscreen, etc.). Thus, for the sake of simplicity, such details are omitted.

By accessing an appropriate option (e.g., menu option) on the cell phone 200 to configure contact rules for a particular person (step 400), the user can select different types of smart dialing configurations at step 405, and two exemplary types of configurations are shown in FIG. 4. In the first configuration type shown at step 410, referred to as a “preferred order” configuration, the user can define an order or hierarchy by which the contact numbers will be smart dialed by the cell phone 200. First, the user selects a contact number for the person at step 411 (e.g., work, home, or cell), sets its priority (first, second, last, etc.) at step 412, and saves the number and the priority to memory at step 413. After the priority of one contact number is handled, the user repeats steps 411 through 414 for the second contact number, the third contact number, etc. In other words, the user can specify that when John is smart dialed, the phone 200 should first call his work phone number, which if not successful is followed by his cell phone, which if not successful is then followed by a call to his cell phone. As noted earlier, making of subsequent calls in the user-specified order can be automatic (i.e., initiated automatically by the cell phone 200 when it understands a call to have failed), or can occur by the user affirmatively smart dialing John a number of times in a row, perhaps within a certain time between each call, as specified by automation rules (FIG. 5). If desired, the automation rules can also be specified at step 412 along with the order priorities.

In a second configuration type, referred to as a “preferred time period” configuration, the user can associate preferences for the various contact numbers for a person to various time periods. This smart dialing configuration is useful when it is recognized that a particular person would likely be preferably called at a particular contact number at a particular time of day, or on particular days. For example, during weekdays, it might be preferable to call a person (John) from 9:00 am to 5:00 pm at his at his work number; from 5:00 pm to 11:00 pm at his cell number; and from 11:00 pm to 9:00 am at his home phone number. Alternatively, during week ends, it may be preferable to call the person's cell number from noon to 6:00 pm and to call the home number during all other time periods. Moreover, it may be specifically desired to set a rule that specifies to never allow the caller to call the person on his work number on the weekends, for example. Such a preferred time period configuration embodiment is shown in steps 420-425 of FIG. 4. First, the user selects and/or enters a contact number at step 421. Then, the user enters period information at step 422 for that contact number. In general, the period information can be any interval of time, such as a time of day, a range of times during the day, a day of the week, a range of days of the week, or a combination thereof. Once the period information is entered, the user's preferences concerning the contact number are saved at step 424, and at step 425, the user can then set up periods for other contact numbers by repeating steps 421 through 424, or the user can terminate the set up process at step 426. If desired, the automation rules can also be specified at step 422 along with the time period information.

In yet another embodiment (not shown in FIG. 4), the user can program smart dialing in the phone 200 to implement a combination of the preferred order and preferred time period configurations for a person or persons. Such an embodiment would allow a user to specify, for example, that during a certain time period, e.g., from 9:00 am to 5:00 pm, that when a person is smart dialed first his work number is called, then his cell, then his home, etc. During the next time period, e.g., from 5:00 pm to 11:00pm, this order can be changed to first his cell, then his home, then work, etc. This combination of the two smart dialing approaches discussed above suggest that other smart dialing configurations are possible, and accordingly that the disclosed embodiments are merely exemplary.

Although the preferred order and preferred time period configurations are described above with respect to a particular person (e.g., John), it should be noted that user-defined preferences of this sort can be globally applied to all persons having multiple contact numbers in a particular user's cell phone 200. In other words, specifying the contact and automation rules can occur either on a per person basis or can be applied as to all persons whose contact information is stored in the cell phone 200.

As discussed above, in addition to setting contact rules (as in FIG. 4), the user can also set automation rules when programming smart dialing into his cell phone 200. In general, the automation rules define how a failed call is determined and governs how subsequent calls to the person, if any, are handled. FIG. 5 depicts exemplary steps for programming automation rules. When automation rule set up is selected at step 500, a user can then first set call failure parameters, i.e., the user can define under what conditions a smart call to a person will be deemed to have failed (step 511). This determination in turn defines the conditions that have to be met before terminating a first-called contact number and initiating a subsequent call to a next contact number. For example, call failure can be defined by a number of rings 512 without an answer, length of call pendency 514 without answer, receipt of a busy signal 516, or transfer to voice mail 518. All of these failure conditions are easily detected or detectable by the cell phone 200, as one skilled in the art will appreciate.

At step 520, the user can set up parameters for how redial attempts to the unsuccessful contact number are handled. For example, the user can specify rule for repeat dialing to the contact number, e.g., if the line was busy or there was no answer. For example, the user can specify a wait time 522, i.e., a period of time (e.g., 5 minutes) that the cell phone 200 waits before attempting to re-dial a failed contact number for the person. The user can specify the number of redial attempts to the failed contact number 524.

At step 530, should re-dial of the first contact number continue to fail, a next contact number for the person can be called. For example, in the “preferred order” configuration discussed earlier, the next contact number in the user-specified priority can be chosen for automatic or manual redial. Or, in the preferred time period configuration, perhaps a next less-preferred number to be dialed during a particular time period can be chosen.

As noted earlier, the inventive concepts disclosed herein can be used with various communication devices known in the art, including, but not limited to, cellular phones, personal digital assistants, and automotive communication systems. Therefore, while terms used in the present disclosure and claims (e.g., as “call,” “dial,” “number,” etc.) may relate to the context of a cellular phone, these terms are not meant to be restrictive but are meant to encompass analogous features of other communication devices. For example, a “number” for a person can include an e-mail address as disclosed herein as well as any conventional phone number, cellular number, fax number, etc. Furthermore, “calling” or “dialing” a number can comprise initiating contact with a number in way other than through a telephone. For example, sending a message to a person via an e-mail message should be understood in the context of this disclosure as “calling” or “dialing” that person.

The foregoing description of the various embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A method of contacting a person using a communication device, the communication device having a plurality of contact numbers stored in memory for the person, the method comprising:
defining in the communication device a preferred order in which the contact numbers for the person will be sequentially called;
calling the person from the communication device so as to call a first preferred contact number for the person consistent with the defined order of contact numbers; and
if contact with the person at the first preferred contact number is unsuccessful, calling at least a second preferred contact number for the person consistent with the defined order of contact numbers.

2. The method of claim 1, wherein calling the person comprises calling the person using a special feature which does not specify a contact number for the person.

3. The method of claim 1, wherein the communication device is selected from the group consisting of a cellular phone, a personal digital assistant, and an automotive communication system.

4. The method of claim 1, wherein the number is selected from the group consisting of a home phone number, a cellular phone number, a work phone number, a fax number, and an e-mail address.

5. The method of claim 1, wherein calling at least a second preferred contact number comprises the communication device automatically calling the second preferred contact number.

6. The method of claim 1, wherein calling at least a second preferred contact number comprises the user affirmatively selecting on option on the communication device to again call the person.

7. The method of claim 1, wherein determining if contact with the person at the first preferred contact number is unsuccessful comprises determining whether a terminating event has occurred, wherein the terminating event is selected from the group consisting of a predetermined number of rings, a predetermined amount of time, a busy signal, and a connection to voicemail.

8. A method of contacting a person using a communication device, the communication device having a plurality of contact numbers stored in memory for the person, the method comprising:
defining in the communication device a plurality of time periods and associating each time period with at least one of the plurality of contact numbers;
calling the person from the communication device;
determining the time period at which the person was called; and
automatically dialing the contact number associated with the determined time period.

9. The method of claim 8, wherein the communication device is selected from the group consisting of a cellular phone, a personal digital assistant, and an automotive communication system.

10. The method of claim 8, wherein the number is selected from the group consisting of a home phone number, a cellular phone number, a work phone number, a fax number, and an e-mail address.

11. The method of claim 8, wherein calling the person comprises calling the person using a special feature which does not specify a contact number for the person.

12. A method for a user to program a communications device, comprising:
entering a person to be contacted into the communications device;
entering a plurality of contact numbers corresponding to the person entered into the communications device;
defining at least one rule to specify which of the plurality of contact numbers is preferred to be called when the person is selected to be called from the communications device; and
automatically calling the preferred contact number consistent with the defined rules in response to the user selecting the person to be contacted.

13. The method of claim 12, wherein the at least one rule specifies the preferred contact number via a time period.

14. The method of claim 12, wherein the at least one rule specifies the preferred contact number via as part of an order of the plurality of contact numbers.

15. The method of claim 12, wherein the preferred contact number is automatically called when a previously preferred contact number has been deemed by the communication device to have failed.

16. The method of claim 12, wherein failure to the previously preferred contact number is defined by a group consisting of exceeding a predetermined number of rings, exceeding a predetermined amount of time, receiving a busy signal, and being forwarded to voicemail.

17. The method of claim 12, wherein the communication device is selected from the group consisting of a cellular phone, a personal digital assistant, and an automotive communication system.

18. The method of claim 12, wherein plurality of contact numbers corresponding to the person is selected from the group consisting of a home phone number, a cellular phone number, a work phone number, a fax number, and an e-mail address.
